(19) United States
(12) Patent Application Publication
(10) Pub. No.: US 2017/0048904 A1
(43) Pub. Date: Feb. 16, 2017

(54) Wireless Data Transmission System

(71) Applicant: Beartooth Radio, Inc., Bozeman, MT (US)

(72) Inventors: Michael C. Monaghan, Bozeman, MT (US); Jefferson M. Jones, Bozeman, MT (US)

(73) Assignee: Beartooth Radio, Inc., Bozeman, MT (US)

(21) Appl. No.: 15/234,838

(22) Filed: Aug. 11, 2016

Related U.S. Application Data
(60) Provisional application No. 62/203,752, filed on Aug. 11, 2015.

(51) Int. Cl. H04W 76/02; H04L 5/00; H04B 17/318; H04W 72/04

(52) U.S. Cl. CPC H04W 76/023; H04W 72/04; H04L 5/0055; H04B 17/318

(57) ABSTRACT

A system and a method are disclosed for enabling communication between mobile communication devices. A mobile communication device receives a message sent by a sender, the message including a recipient, a message identification, and a payload. The mobile communication device determines whether it is the intended recipient of the message. If the mobile device that received the message is the intended recipient, the mobile device sends an acknowledgement response message to the sender of the message. Otherwise, if the mobile device that received the message is not the intended recipient, the mobile device forwards the message to a second mobile device.

### CROSS REFERENCE To RELATED APPLICATION

This application claims the benefit of U.S. Provisional Application No. 62/203,752, entitled WIRELESS DATA TRANSMISSION SYSTEM, filed Aug. 11, 2015, which is incorporated by reference herein in its entirety.

### FIELD

The disclosure generally relates to the field of mobile device communications and more specifically to peer-to-peer communications of mobile devices.

### BACKGROUND

While mobile computing devices provide a wide range of uses and software applications for users, mobile computing devices communicate with each other using network (e.g., a cellular network or the internet). For instance, mobile computing devices may connect to the internet via WiFi or a cellular data connection (e.g., Long Term Evolution (LTE) or 4G or 5G). In many remote regions, connections to these networks are unavailable. For instance, a mobile computing device may not be able to connect to the internet using a cellular data connection in the middle of a desert.

Users may want to be able to communicate with each other in situations where connections to a network are unavailable. For instance, users may want to be able to exchange messages between themselves during a trip to a remote location. Accordingly, there is a need for improved methods, apparatus, and systems for mobile or wireless communication.

### SUMMARY

In summary, the detailed description presents innovations in the art of wireless communication between mobile devices, particularly when a cellular or other wide area network is unavailable.

According to one aspect of the innovations described herein, a transmitting device is enabled to communicate through an intermediary mobile device to a receiving device. If the intermediary mobile device recognizes that a received message has a destination other than itself, then the intermediary mobile device retransmits the message.

According to another aspect of the innovations described herein, the transmitting device and the receiving device are individually operable to communicate over a network, and the communication via the intermediary device bypasses the network. In some embodiments, the intermediary device is also operable to communicate over the bypassed network. In some embodiments, the communication via the intermediary device proceeds only when communication from the transmitting device to the receiving device over the network is unavailable.

According to another aspect of the innovations described herein, transmitted and received messages may include message identifiers. If the intermediary mobile device recognizes a received message as one that it has previously transmitted or that it has previously received and retransmitted, then the intermediary mobile device does not transmit or retransmit the message again.

According to another aspect, a mobile device that receives a message, whose destination is itself, proceeds to transmit an acknowledgment response. An intermediary device receiving the acknowledgement response for a message originated by a device other than itself, proceeds to retransmit the acknowledgment response. In some embodiments, the intermediary device only retransmits the acknowledgment response if it earlier retransmitted the message being responded to.

According to another aspect, the acknowledgment response includes a message identifier corresponding to a message identifier of the received message that is being acknowledged. If the intermediary mobile device recognizes the acknowledgment response as one that it has previously transmitted or that it has previously received and retransmitted, then the intermediary mobile device does not transmit or retransmit the acknowledgment response again.

According to another aspect, the intermediary mobile device may wait for a preset time before retransmitting a message. If an acknowledgment to the message is received during the preset time, then the message is not retransmitted by the intermediary mobile device. If no acknowledgment response to the message is received during the preset time, then the message is retransmitted by the intermediary mobile device.

According to another aspect, a device that has transmitted a message, may retransmit the message if it does not receive an acknowledgment response within a preset time.

According to another aspect, a mobile device, having a message waiting to be transmitted, monitors noise or signal strength in a channel. Responsive to determining that the average signal strength in the channel is above a threshold, the mobile device continues monitoring the channel and does not transmit the message. Responsive to determining that the average signal strength in the channel is below the threshold, the mobile device transmits the message. In some embodiments, the threshold may be adjusted dynamically.

According to another aspect, mobile devices according to embodiments described herein communicate on unlicensed bands within the electromagnetic spectrum.

According to another aspect, the messages described herein may be encoded by a transmitting mobile device and decoded by a receiving mobile device.

According to another aspect, messages are encrypted. In some embodiments, message encryption utilizes 256-bit symmetric key encryption.

According to another aspect, mobile devices may maintain a first storage in which messages waiting to be transmitted are stored. Mobile devices may maintain a second storage in which a correspondence is maintained between transmitted messages and message identifiers. Mobile devices may maintain a third storage in which delivered messages are stored. According to various embodiments, some or all of the above storages may be maintained. According to various embodiments, two or more of the above storages may be consolidated together. According to various embodiments, the retention times and policies of these storages may vary.

According to another aspect, a message controller may control the order in which messages are transmitted from an outgoing message buffer. In some embodiments, messages are transmitted in the same order as they were stored in the outgoing message buffer. In other embodiments, messages are transmitted in a priority order.

According to another aspect, devices operating according to embodiments described herein may operate in a client-server environment. In some embodiments one or more devices may operate as a client. In some embodiments, one or more devices may operate as a server.

According to another aspect, devices operating according to embodiments described herein may operate as peers in a peer-to-peer environment.

According to another aspect, a device operating according to an embodiment described herein may maintain a list of other devices that are within range of the device. Another device may be added to the list if a message or acknowledgment response is received from the another device. Another device may be removed from the list if no message or acknowledgment response is received from the another device within a preset time period.

The disclosed embodiments have other advantages and features which will be more readily apparent from the detailed description, the appended claims, and the accompanying figures (or drawings). A brief introduction of the figures follows.

### BRIEF DESCRIPTION OF THE DRAWINGS

FIG. 1 illustrates one embodiment of components of an example machine able to read instructions from a machine-readable medium and execute them in a processor.

FIG. 2 illustrates a block diagram of a system environment of multiple mobile devices communicating with each other, according to one embodiment.

FIG. 3 illustrates a block diagram of an architecture of a client device, according to one embodiment.

FIG. 4 illustrates a flow diagram of a method for monitoring the noise of a wireless communication channel, according to one embodiment.

FIG. 5 illustrates a flow diagram of a process for sending a message to a receiving mobile device not directly reachable by a transmitting mobile device, according to one embodiment.

FIGS. 6A-6D illustrate block diagrams of a message exchange between mobile devices when the transmitting mobile device attempts to send a message to a receiving mobile device that is not directly reachable by the transmitting mobile device, according to one embodiment.

### DETAILED DESCRIPTION

The Figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable, similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Embodiments of a disclosed system, method, and computer readable storage medium enable communication between mobile communication devices. In some embodiments, a mobile communication device receives a message sent by a sender, the message including a recipient, a message identification, and a payload. The mobile communication device determines whether it is the intended recipient of the message. If the mobile device that received the message is the intended recipient, the mobile device sends an acknowledgement response message to the sender of the message. Otherwise, if the mobile device that received the message is not the intended recipient, the mobile device forwards the message to a second mobile device.

### Computing Machine Architecture

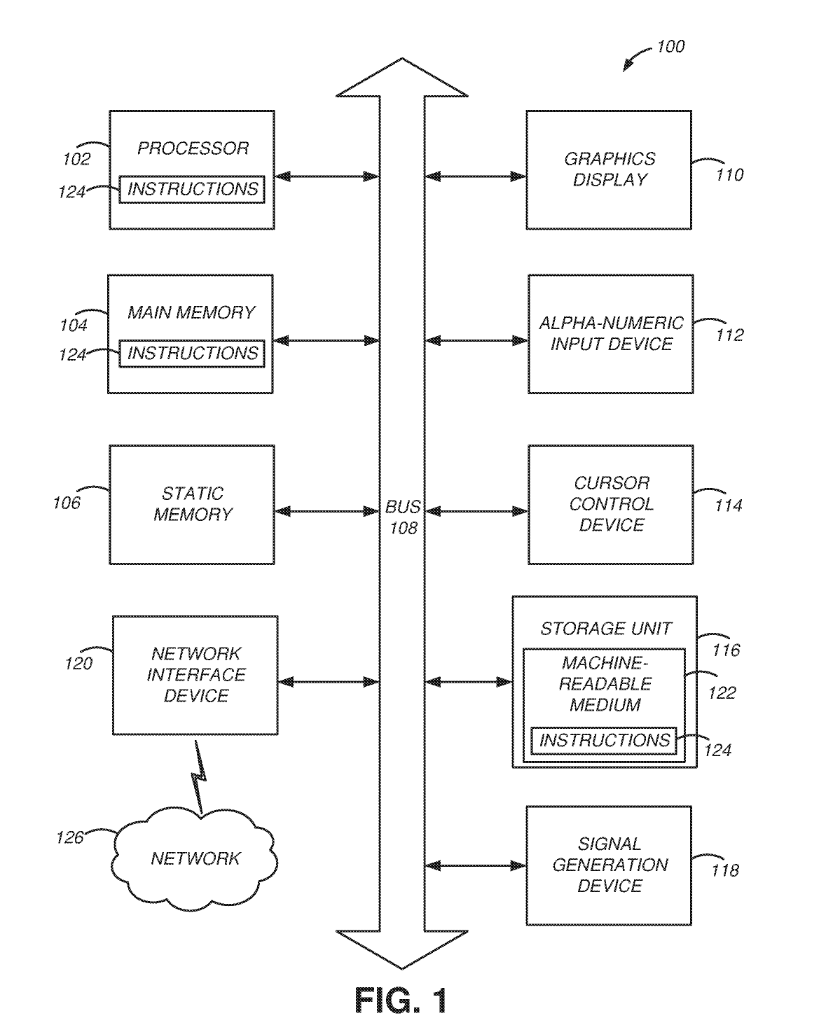

FIG. 1 is a block diagram illustrating components of an example machine able to read instructions from a machine-readable medium and execute them in one or more processors (or controllers). Specifically, FIG. 1 shows a diagrammatic representation of a machine in the example form of a computer system 100 within which instructions 124 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 124 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 100 includes a processor 102 (e.g., a central processing unit (CPU), a graphics processing unit (GPU), a digital signal processor (DSP), one or more application specific integrated circuits (ASICs), a controller, one or more radio-frequency integrated circuits (RFICs), or any combination of these), a main memory 104, and a static memory 106, which are configured to communicate with each other via a bus 108. The computer system 100 may further include graphics display unit 110 (e.g., a plasma display panel (PDP), a liquid crystal display (LCD), a projector, a cathode ray tube (CRT), a light-emitting diode display (LED), an organic light-emitting diode display (OLED), a quantum diode light-emitting diode display (QD-LED), or an electrophoretic display). The computer system 100 may also include alphanumeric input device 112 (e.g., a keyboard), a cursor control device 114 (e.g., a mouse, a trackball, a joystick, a motion sensor, or other pointing instrument), a storage unit 116, a signal generation device 118 (e.g., a speaker), and a network interface device 120, which are also configured to communicate via the bus 108.

The storage unit 116 includes a non-transitory machine-readable medium 122 on which is stored instructions 124 (e.g., software) embodying any one or more of the methodologies or functions described herein. The instructions 124 (e.g., software) may also reside, completely or at least partially, within the main memory 104 or within the processor 102 (e.g., within a processor's cache memory) during execution thereof by the computer system 100; the main memory 104 and the processor 102 also constitute machine-readable media. The instructions 124 (e.g., software) may be transmitted or received over a network 126 via the network interface device 120.

While machine-readable medium 122 is shown in an example embodiment to be a single medium, the term “machine-readable medium” should be taken to include a single medium or multiple media (e.g., a centralized or distributed database, or associated caches and servers) able to store instructions (e.g., instructions 124). The term “machine-readable medium” shall also be taken to include any medium that is capable of storing instructions (e.g., instructions 124) for execution by the machine and that cause the machine to perform any one or more of the methodologies disclosed herein. The term “machine-readable medium” includes, but is not limited to, data repositories in the form of solid-state memories, optical media, and magnetic media.

### System Environment

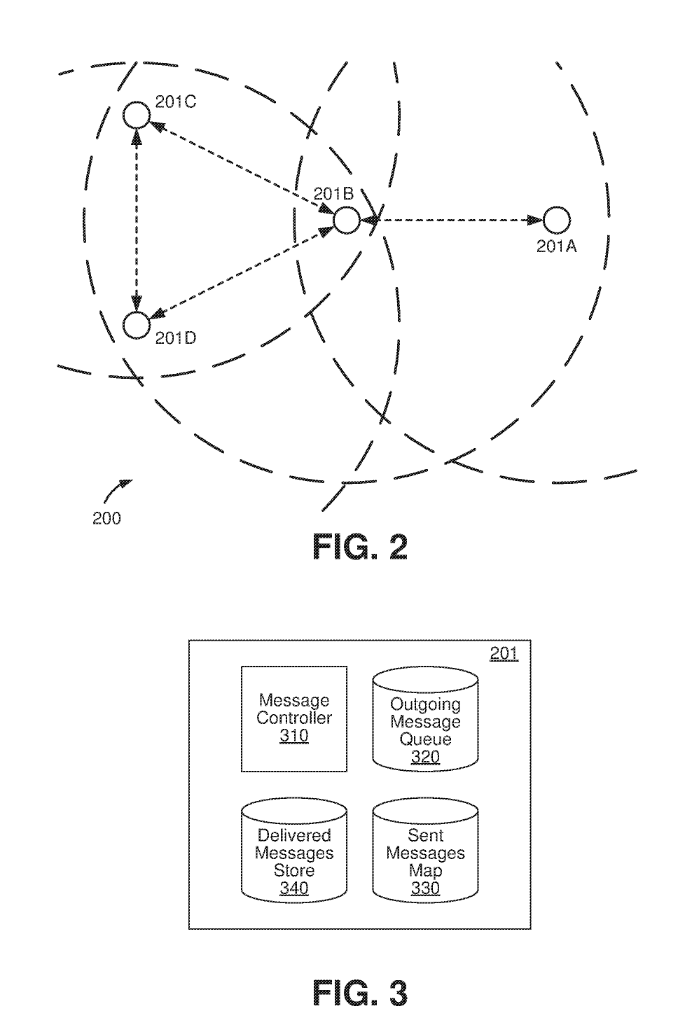

FIG. 2 is a block diagram illustrating a system environment 200 of multiple mobile devices communicating with each other. The system environment 200 includes various mobile devices 201 capable of sending wireless data transmissions to one or more other mobile devices 201. Each mobile device is capable of wirelessly communicating with another mobile device 201 that is located within threshold distance of the mobile device. For instance, in the exemplary embodiment of FIG. 2, mobile device 201A is capable of wirelessly communicating with mobile device 201B; mobile device 201B is capable of wirelessly communicating with mobile devices 201A, 201C, and 201D; mobile device 201C is capable of wirelessly communicating with mobile devices 201B and 201D; and mobile device 201D is capable of wirelessly communicating with mobile devices 201B and 201C.

Mobile devices 201 may use an unlicensed wireless spectrum, for example, 900 MHz, 2.4 GHz, 5 GHz, or 60 GHz. Alternatively, mobile device 201 may use a licensed wireless spectrum, for example, 700 MHz. The aforementioned frequencies are only exemplary, and the wireless data transmission system may utilize any appropriate radio, microwave, infrared, or visible-light frequency. The range of communication between two mobile devices may depend on the power of the wireless transmitter of the mobile devices, the frequency of the wireless signal (e.g., a higher frequency signal may decay faster with distance than a lower frequency signal), physical obstructions between mobile devices, error detection and/or error correction features of the protocol used for the wireless transmission, etc.

To communicate with a receiving mobile device, a transmitting mobile device encodes a message using a wireless transmission protocol and transmits a wireless signal containing the encoded message. For instance, the transmitting mobile device generates an electromagnetic signal using an antenna. The receiving mobile device receives the wireless signal transmitted by the transmitting mobile device and decodes the message. Here, the transmitting mobile device and the receiving mobile device communicate with each other without being connected to a network.

To maintain privacy, messages may be encrypted. In some embodiments, message encryption is performed using 256-bit symmetric key encryption. Encrypted messages may include include encrypted portions, such as a payload, and unencrypted portions comprising a message identifier, address information, protocol information, and other non-sensitive information.

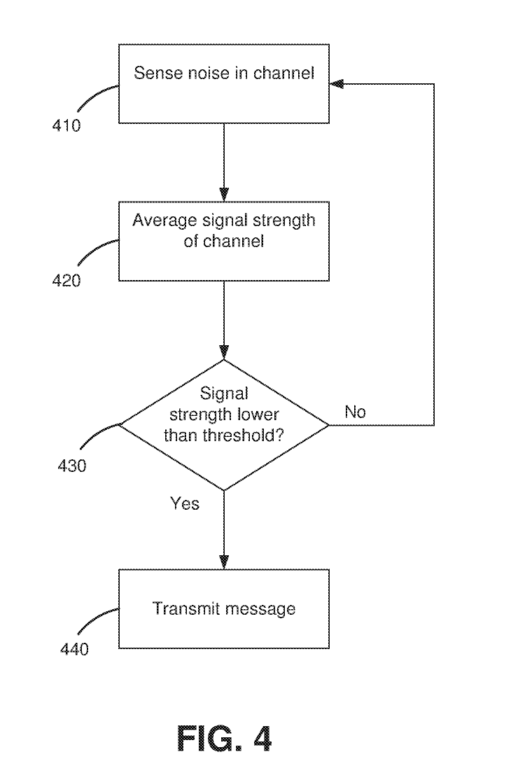

FIG. 3 illustrates a block diagram of an architecture of a client device 201. A hardware configuration of the client device 201 can be the example computer system 100 described with FIG. 1. The client device 201 shown in FIG. 3 includes a message controller 310, an outgoing message queue 320, a sent messages map 330, and a delivered messages store 340. The message controller 310 sends and receives message packets to and from other mobile devices wirelessly coupled to the mobile device 201. The message queue stores outgoing messages to be sent by the message controller 310. The sent messages map 330 stores mappings between sent messages and a corresponding message identification associated with each of the sent messages. The delivered messages store 340 stores messages that are confirmed by the message controller 310 to be successfully delivered. It is noted that each component may be configured as a hardware and/or software component. A software configuration comprises program code (or instructions) executable by the client device 201.

The message controller 310 sends and receives message packets to and from other mobile devices wirelessly coupled to the mobile device 201. The message controller 310 determines when to send messages to other mobile devices and decodes received messages from other mobile devices. A transmission window is a time interval identified as being suitable for a wireless transmission, and in some embodiments is identified at least partly based on measurements of one or more wireless channels. For instance, message controller 310 monitors the noise floor of channels allocated for wireless transmissions between mobile devices, dynamically adjusts the noise threshold, and identifies transmission windows in which to wirelessly transmit a signal to other mobile devices.

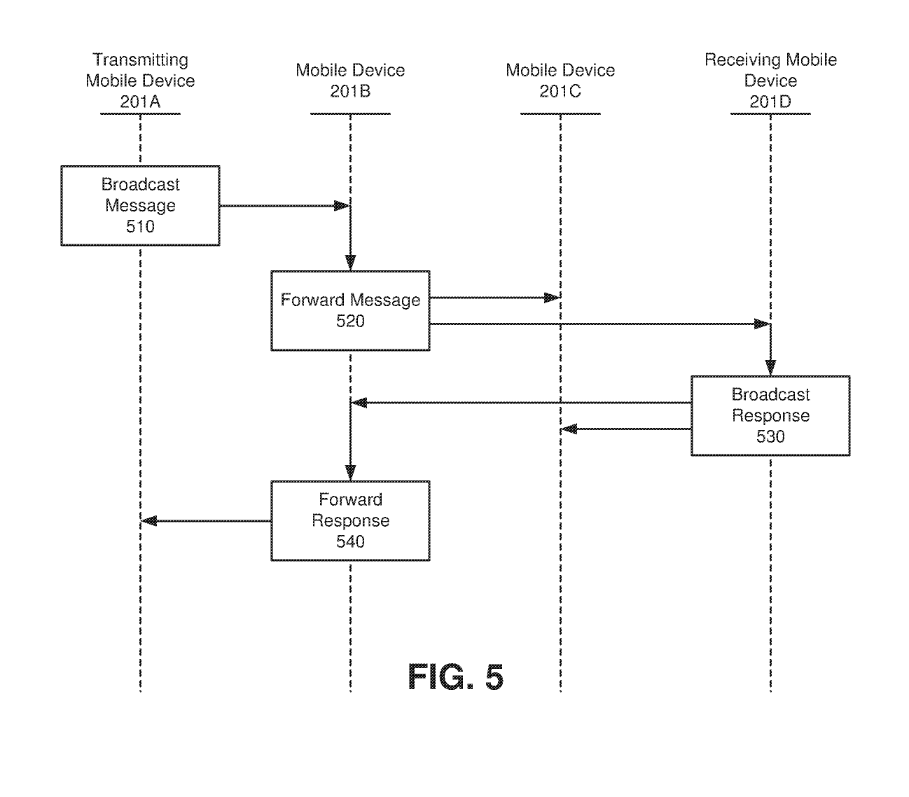

FIG. 4 illustrates a flow diagram of a method for monitoring the noise of a wireless communication channel, in accordance with an example embodiment. To monitor the noise levels on a specific wireless channel, the message controller 310 senses 410 the noise in the channel and takes an average 420 of the signal strength in the sensed channel within a set time period. For instance, the message controller 310 determines the average of the signal strength in the sensed channel during the previous microsecond. If the signal strength is lower than a threshold value, the message controller 310 transmits a message via the sensed channel. Otherwise, the process is repeated until the signal strength in the sensed channel is lower than the threshold value.

In some embodiments, the message controller 310 monitors the channel before a message is to be transmitted by the mobile device 201. In other embodiments, the channel is sensed periodically.

Referring back to FIG. 3, the message controller stores messages to be wirelessly transmitted in the outgoing message queue 320. The messages stored in the outgoing message queue 320 are sent by the message controller 310 after the message controller 310 has determined that the noise level in a wireless transmission channel is lower than a threshold value. In some embodiments, messages in the outgoing message queue are stored in a first-in-first-out (FIFO) queue. That is, messages that are stored first into the outgoing message queue are sent before messages that are stored later into the outgoing message queue. In other embodiments, certain messages may be sent before messages that were stored earlier into the outgoing message queue. For instance, high priority messages may be sent before low priority messages that were stored into the outgoing message queue before the high priority messages were stored into the outgoing message queue.

After the message controller 310 sends a message stored in the outgoing message queue 320, the message is removed from the outgoing message queue 320 and stored together with a message identification in the sent messages map 330. If an acknowledgement message including the message identification is not received within a preset time period, as determined by the message controller 310, the message is resent. Retransmission of a message may be performed a predetermined number of times (e.g., 3 times). If an acknowledgment including the message identification is not received after the predetermined number of retransmissions, the message is marked as failed. In some embodiments, the user is notified that the transmission of a message has failed. If an acknowledgement message including the message identification is received, the message is removed from the sent messages map 330 and stored in the delivered messages store 340.

### Data Transmission Protocol

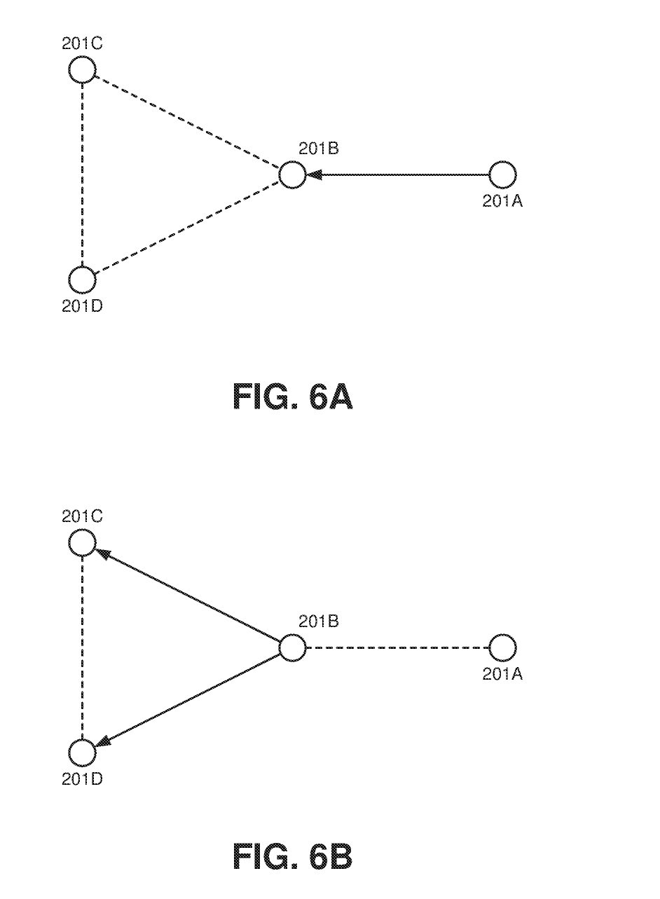

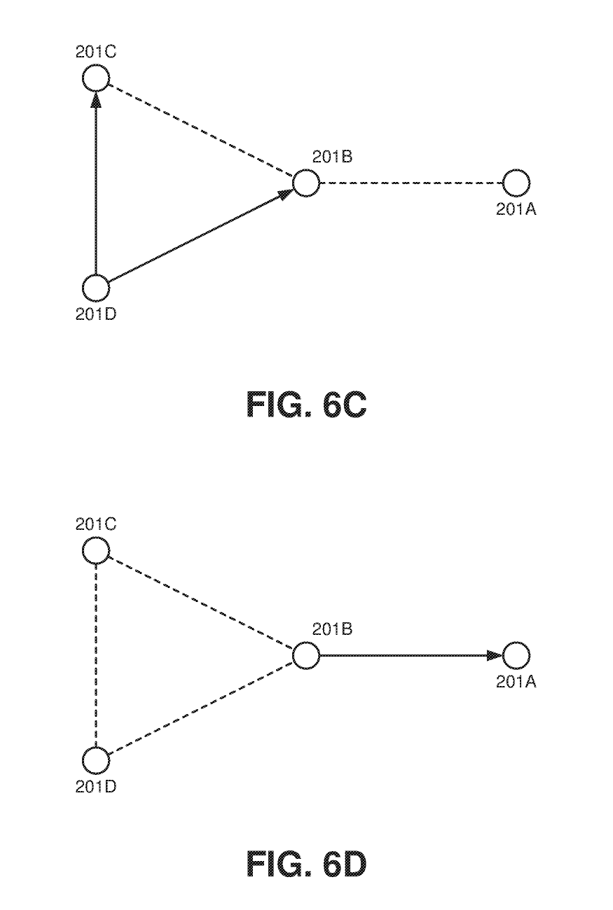

FIG. 5 illustrates a flow diagram of a process for sending a message to a receiving mobile device 201D not directly reachable by the transmitting mobile device 201A. FIGS. 6A-6D illustrate block diagrams of the message exchange between mobile devices when a transmitting mobile device 201A sends a message to a receiving mobile device 201D that is not directly reachable by the transmitting mobile device 201A. As seen in FIG. 2, mobile device 201D is not within the wireless signal range of mobile device 201A. As such, mobile device 201A is not capable of directly sending wireless transmissions to mobile device 201D. In the example of FIG. 2, only mobile device 201B is within the wireless signal range of mobile device 201A, and mobile device 201D is within the wireless signal range of mobile device 201B.

At step 510, transmitting mobile device 201A broadcasts a message directed to receiving mobile device 201D. The transmitting mobile device 201A assigns a message identification to the broadcasted message and stores the message identification in the sent message map 330. The broadcasted message includes the message identification and a payload.

Since mobile device is not within the range of the wireless signal of mobile device 201A, mobile device 201D does not receive the message broadcasted by mobile device 201A. Instead, as illustrated in FIG. 6A, mobile device 201B, which is within the range of the wireless signal of mobile device 201A, receives the message broadcasted by mobile device 201A.

At step 520, mobile device 201B forwards the message broadcasted by the transmitting mobile device 201A. As illustrated in FIG. 6B, since mobile devices 201C and 201D are within the wireless signal range of mobile device 201B, mobile devices 201C and 201D receive the message forwarded by mobile device 201B. In some embodiments, mobile device 201B waits for a set amount of time before forwarding the message. If an acknowledgement message is not received within the set amount of time, mobile device 201B forwards the message broadcasted by mobile device 201A. In other embodiments, mobile device 201B immediately forwards the message broadcasted by transmitting mobile device 201A.

In some embodiments, mobile device 201B inspects the received message broadcasted by transmitting mobile device 201A and determines that a recipient of the message broadcasted by the transmitting mobile device 201A is receiving mobile device 201D. In some embodiments, if the mobile device 201B determines that it is not the intended recipient of the message, mobile device 201B forwards the message. Otherwise, if mobile device 201B determines that it is the intended recipient of the message, mobile device 201B broadcasts an acknowledgement response message. Mobile device 201B may determine whether it is the intended recipient of the message by extracting a recipient address or other recipient identifier from the message, and comparing with its own address or other identifier.

In some embodiments, mobile device 201B stores the forwarded message in the sent messages map of mobile device 201B. If the mobile device 201B does not receive an acknowledgement message associated with the forwarded message, mobile device 201B sends a negative acknowledgement message to transmitting mobile device 201A. Additionally, if a duplicate message (i.e., a message including a message identification included in a previously received message) is received, mobile device 201B may not forward the duplicate message. That is, mobile device 201B may search the sent messages map 330 and determine that a message including a message identification number was previously received. If a determination is made that a message including the message identification number was not previously received, mobile device 201B forwards the message. Otherwise, if a determination is made that a message including the message identification was previously received, the duplicate message is ignored.

After receiving the forwarded message and determining that mobile device 201D is the intended recipient of the message, receiving mobile device 201D broadcasts an acknowledgement response message at step 530. Since transmitting mobile device 201A is not within the wireless signal range of receiving mobile device 201D, transmitting mobile device 201A does not receive the acknowledgement response message broadcasted by receiving mobile device 201D. As illustrated in FIG. 6C, mobile devices 201B and 201C, that are within the wireless signal range of receiving mobile device 201D, receive the broadcasted acknowledgment response message from receiving mobile device 201D.

Since mobile device 201C received an acknowledgement message before forwarding the message received by mobile device 201B, mobile device 201C does not forward the acknowledgment response message broadcasted by mobile device 201D. Mobile device 201B, which forwarded the message broadcasted by transmitting mobile device 201A forwards the acknowledgement response message broadcasted by receiving mobile device 201D. As seen in FIG. 6D, since transmitting mobile device 201A is within the wireless signal range of mobile device 201B, the transmitting mobile device 201A receives the acknowledgement response message forwarded by mobile device 201B.

The transmitting mobile device 201A identifies the message identification included in the acknowledgement response message and determines that the received acknowledgement response message is for the message previously broadcasted by the transmitting mobile device 201A. The transmitting mobile device 201A then removes the message associated with the message identification included in the acknowledgement response message from the sent messages map 330 and places the message in the delivered messages store 340.

In some embodiments, mobile devices 201 maintain a list of devices that are within range of the wireless signal of the mobile device 201. For instance, if a message or an acknowledgement message is received from another mobile device 201, the mobile device receiving the message or the acknowledgement message stores an identification of the mobile device from which the message or the acknowledgement message was received in the list of devices that are within range of the mobile device. Additionally, if a message or an acknowledgement message is not received within a set amount of time from a specific mobile device included in the list of mobile devices that are within range of the wireless signal of the mobile device 201, the specific mobile device may be removed from the list.

### Additional Configuration Considerations

Multiple mobile devices may thus communicate with each other during instances where a network, to which those multiple mobile devices can connect, is not available. The multiple mobile devices may use an unlicensed wireless spectrum to communicate with each other. Additionally, using the described methodology, two mobile devices that are not within range of each other to establish a direct wireless link may communicate with each other through an intermediary that can establish a direct wireless link with each of the two mobile devices.

Throughout this specification, plural instances may implement components, operations, or structures described as a single instance. Although individual operations of one or more methods are illustrated and described as separate operations, one or more of the individual operations may be performed concurrently. Additionally, the operations may be performed in an order other than the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) or firmware as a hardware module that operates to perform certain operations as described herein.

In various embodiments, a hardware module may be implemented mechanically or electronically, and may be configured to perform certain operations either permanently or temporarily. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such transitory or non-transitory signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation, and details of the methods and apparatus disclosed herein without departing from the spirit and scope defined in the appended claims.

What is claimed is:

1. A method comprising:
receiving, by a mobile device from a sender, a message, the message including a recipient, a message identification, and a payload, the message received via a wireless communication channel;
determining, by the mobile device, whether the mobile device is the recipient of the message;
transmitting, in at least one instance and responsive to determining that the mobile device is the recipient of the message, an acknowledgement response message to the sender, the acknowledgement response message including the message identification; and
forwarding, in at least one instance and responsive to determining that the mobile device is not the recipient of the message, the message via the wireless communication channel to a second mobile device.

2. The method of claim 1 further comprising:
forwarding, responsive to receiving an acknowledgement response message including the message identification, the received acknowledgement response message to the sender; and
transmitting, responsive to not receiving an acknowledgement response message within a preset time period, a negative acknowledgment response message to the sender.

3. The method of claim 2, further comprising:
storing, responsive to forwarding the message to the second mobile device, an association between the message and the message identification; and
removing, responsive to receiving the acknowledgement response message including the message identification, the association between the message and the message identification.

4. The method of claim 1 wherein forwarding the message to a second mobile device comprises:
storing the message in a queue;
sensing a signal strength in the wireless communication channel;
determining an average of the signal strength within a set time period;
transmitting, responsive to determining that the average of the signal strength is below a threshold value, the message via the wireless communication channel; and
removing the message from the queue.

5. The method of claim 1 further comprising:
determining whether a previous message including the message identification was previously received;
responsive to determining that a previous message including the message identification was previously received and that the mobile device is not the recipient of the message, not forwarding the message to the second mobile device; and
responsive to determining that a previous message including the message identification was not previously received and that the mobile device is not the recipient of the message, forwarding the message to the second mobile device.

6. The method of claim 1, wherein receiving the message from the sender comprises:
receiving a wireless signal transmitted from the sender, the wireless signal comprising an encoded representation of the message; and
decoding the wireless signal to retrieve the message.

7. The method of claim 6, wherein the received wireless signal is in an unlicensed frequency.

8. The method of claim 6, wherein the sender is a mobile device.

9. A non-transitory computer readable medium storing instructions which, when executed by a processor of a mobile device, are operable to cause the processor to:
receive, from a sender, a message, the message including a recipient, a message identification, and a payload, the message received via a wireless communication channel;
determine whether the mobile device is the recipient of the message;
transmit, in at least one instance and responsive to determining that the mobile device is the recipient of the message, an acknowledgement response message to the sender, the acknowledgement response message including the message identification; and
forward, in at least one instance and responsive to determining that the mobile device is not the recipient of the message, the message via the wireless communication channel to a second mobile device.

10. The method of claim 1, wherein the message received by the mobile device is encrypted.

11. The non-transitory computer readable medium of claim 10, wherein the instructions further cause the processor to:
forward, responsive to receiving an acknowledgement response message including the message identification, the received acknowledgement response message to the sender; and
transmit, responsive to not receiving an acknowledgement response message within a preset time period, a negative acknowledgment response message to the sender.

12. The non-transitory computer readable medium of claim 11, wherein the instructions further cause the processor to:
store, responsive to forwarding the message to the second mobile device, an association between the message and the message identification; and
remove, responsive to receiving the acknowledgement response message including the message identification, the association between the message and the message identification.

13. The non-transitory computer readable medium of claim 10, wherein the instructions for forwarding the message to a second mobile device cause the processor to:
store the message in a queue;
sense a signal strength in the wireless communication channel;
determine an average of the signal strength within a set time period;
transmit, responsive to determining that the average of the signal strength is below a threshold value, the message via the wireless communication channel; and
remove the message from the queue.

14. The non-transitory computer readable medium of claim 10, wherein the instructions further cause the processor to:
determine whether a previous message including the message identification was previously received;
responsive to determining that a previous message including the message identification was previously received and that the mobile device is not the recipient of the message, not forward the message to the second mobile device; and
responsive to determining that a previous message including the message identification was not previously received and that the mobile device is not the recipient of the message, forwarding the message to the second mobile device.

15. The non-transitory computer readable medium of claim 10, wherein the instructions for receiving the message from the sender cause the processor to:
receive a wireless signal transmitted from the sender, the wireless signal comprising an encoded representation of the message; and
decode the wireless signal to retrieve the message.

16. The non-transitory computer readable medium of claim 15, wherein the received wireless signal transmitted is in an unlicensed frequency.

17. The non-transitory computer readable medium of claim 15, wherein the sender is a mobile device.

18. A system comprising:
a first mobile device and a second mobile device directly connected via a first wireless communication channel;
a third mobile device directly connected to the second mobile device by a second wireless communication channel;
wherein the first mobile device is configured to transmit a message to the second mobile device via the first wireless communication channel; and
wherein the second mobile device is configured to:
receive the message transmitted by the first mobile device, the message including a recipient, a message identification, and a payload;
determine whether the second mobile device is the recipient of the message;
transmit, in at least one case and responsive to determining that the second mobile device is the recipient of the message, an acknowledgement response message to the first mobile device, the acknowledgement response message including the message identification; and
forward, in at least one case and responsive to determining that the second mobile device is not the recipient of the message, the message via the second wireless communication channel to the third mobile device.

19. The system of claim 18, wherein the second mobile device is further configured to:
forward, responsive to receiving, from the third mobile device, an acknowledgement response message including the message identification, the received acknowledgement response message to the first mobile device; and
transmit, responsive to not receiving an acknowledgement response message within a preset time period, a negative acknowledgment response message to the first mobile device.

20. The system of claim 18, wherein message transmission is encrypted.
